(19) United States
(12) Patent Application Publication
(10) Pub. No.: US 2017/0161150 A1
(43) Pub. Date: Jun. 8, 2017

(54) METHOD AND SYSTEM FOR EFFICIENT REPLICATION OF FILES USING SHARED NULL MAPPINGS WHEN HAVING TRIM OPERATIONS ON FILES

(71) Applicant: Dell Products L.P., Round Rock, TX (US)

(72) Inventors: Miki ROSIN, Brookline, MA (US); Dan Bardov, Hod Hasharon (IL); Itay Dar, Rishon le zion (IL)

(21) Appl. No.: 14/960,554

(22) Filed: Dec. 7, 2015

(51) Int. Cl. G06F 11/14; G06F 17/30

(52) U.S. Cl. CPC G06F 11/1451; G06F 11/1469; G06F 17/30581; G06F 2201/84

(57) ABSTRACT

A method and a system for efficient replication of files using shared null mappings when having trim operations on files are provided herein. The method may include: creating at time t₀, a snapshot S₀ of a file system, wherein said file system includes at least one extent and at least one unmapped sector, wherein the data extent and the at least one unmapped extent are indicated as owned by snapshot S₀; creating at time t₁, wherein t₁>t₀, a snapshot S₁ of the file system, wherein the at least one unmapped extent of time t₀ remains unmapped at time t₁; and indicating the at least one unmapped extent as an unmapped extent shared by snapshot S₁ and owned by snapshot S₀. The system may implement the aforementioned method on a distributed shared file system.

### FIELD OF THE INVENTION

The present invention relates generally to the field of distributed shared file systems (DSFS), and more particularly to a method and system for performing snapshots in distributed such systems.

### BACKGROUND OF THE INVENTION

FIG. 1 is a block diagram illustrating non-limiting exemplary architecture of a distributed file system 100 implementing a Network Attached Storage (NAS) in accordance with the prior art. Distributed file server 120 may include a plurality of nodes (aka controllers) 130-1 to 130-x connected to a bus 180 operating on Internet Small Computer Systems Interface (iSCSI), a fiber channel (FC) or the like.

Bus 180 connects distributed file server 120 to a plurality of block storage devices 190 possibly configured as a part of a Storage Area Network (SAN) device aligned, for example, in a Redundant Array of Independent Disks (RAID) configuration.

Each of nodes 130-1 to 130-x may include a central processing unit (CPU) 160-1 to 160-x respectively, and memory units 150-1 to 150-x respectively, on which several processes are being executed. Nodes 130-1 to 130-x may communicate with a plurality of clients over network protocols such as Network File System (NFS) and Server Message Block (SMB).

Some of the processes running over nodes 130-1 to 130-x may include file system daemons (FSDs) 170-1 to 170-x. Each of nodes 130-1 to 130-x may include one or more FSDs which serve as containers for services and effectively control files in distributed file server 120.

Files in distributed file server 120 are distributed across FSDs 170-1 to 170-x and across nodes 130-1 to 130-x. Distributed file server 120 may also include file servers 140-1 to 140-x in at least one of nodes 130-1 to 130-x, wherein each of file servers 140-1 to 140-x may receive file system connect requests 112 from clients such as client machine 110.

Such client machine 110 may include, in a non-limiting example, Windows™ clients communicating over Server Message Block (SMB) protocol. Upon receiving such a connect request 112, file servers 140-1 to 140-x refer the requests to one of FSDs 170-1 to 170-x that holds the required file.

In order to preserve the state of a file system such as distributed file system 120 at specific points in time either for the entire file system or for a group of files inside the file system, snapshots may be created. Snapshots can be taken at every timestamp. Whenever clients write new data to the active file system, the snapshot for the new timestamp reflects the changes to the data by updating the memory mapping to the file system. There is a plurality of implementations for taking snapshots but the common concept is that the memory mapping to the file system held by each of the snapshots enables to go back to the content of the active file for each corresponding timestamp of the snapshots without the need to actually copy the content of the active file every time a snapshot is taken.

FIG. 2 is a block diagram an aspect of a system in accordance with the prior art. A classic snapshot scenario showing three stages over time is depicted in steps A to C. Distributed file system 210 may have a similar architecture as aforementioned file system 120 of FIG. 1. Active file 220 may include a plurality of contiguous regions of computer storage medium reserved for a file (hereinafter referred to as: extents) A, B, and C on a file system.

Step A is depicting timestamp t₀ after a respective snapshot S₀ 230 has been taken. Step B is depicting timestamp t₁ before a new snapshot has been taken, and step C in timestamp t₁ after a new snapshot S₁ 232 has been taken.

In step A, when the basic snapshot 230 is taken (e.g. in t=t₀) the snapshot needs to hold the entire memory mapping of the content of the active file 220 onto the corresponding blocks on file system 210. In step B, when a client writes new data, for example C′ over C in the active file 222, a new mapping of this content onto the extent is being updated in the active file 222 but not so in snapshot S₀ 230 which still holds the mapping to t=t₀. In step C, when a new snapshot S₁ 232 is taken, the mapping to the storage unit of new data C′ is updated.

U.S. Pat. No. 7,913,046 which is incorporated herein by reference in its entirety teaches the concept of snapshot ownership in regards to data which a specific snapshot points to. In reference to FIG. 2, basic snapshot S₀ 230 is said to “own” all extents A, B, and C since this is the first time a snapshot was taken. In the next timestamp, after a new snapshot is taken (e.g., S₁ 232), data is distinguished into “shared data” such as A and B since both snapshot S₀ and S₁ share them, and C′ which is owned data and is owned by snapshot S₁ (and not owned by snapshot S₀)

As disclosed by U.S. Pat. No. 7,913,046, the introduction of ownership concept to snapshots has increased the efficiency of various operations carried by the file system over snapshots, such as replication and backup. These operations usually require calculating the difference (hereinafter referred to as “delta”) between two snapshots.

However, the existing technology does not offer any efficient manner to cope with areas in the memory that are not mapped to media. These unused areas may be areas that either originally remained unmapped upon creation of a file (empty sections) or that later on, the mapping was intentionally removed (e.g. by file punching operations or by a file size truncation either down or up). The unmapped areas are referred herein to as “nulls” or “null extents”.

It would be therefore advantageous to be able to deal with nulls or null extents when creating snapshots of the file system.

### SUMMARY OF THE INVENTION

Some embodiments of the present invention provide a method for efficient replication of files using shared null mappings when having trim operations on files. The method may include the following steps: creating at time t₀, a snapshot S₀ of a file system, wherein the file system includes at least one mapped data extent and at least one unmapped extent. The data extent and the at least one unmapped extent are indicated as owned by snapshot S₀; creating at time t₁, wherein t₁>t₀, a snapshot S₁ of the file system, wherein the at least one unmapped extent of time t₀ remains unmapped at time t₁; and indicating said at least one unmapped extent as an unmapped extent shared by snapshot S₁ and owned by snapshot S₀. The system may implement the aforementioned method on a distributed shared file system.

According to some embodiments of the present invention, the aforementioned method may further include the step of applying at least one file system operation that requires replicating extents to a target file. In such a case, once an unmapped extent is determined as shared, the ordinary replication operations simply ignore the shared extent (whether it is a data extent or an unmapped extent) and carries on only with replication operations on the owned extent (data and null extents alike).

According to some embodiments of the present invention, the at least one unmapped extent may include at least one of: an area that originally remained unmapped upon creation of a file; an area whose mapping was intentionally removed after creation of the file.

The method according to claim 3, wherein the mapping was intentionally removed from the file by at least one of: a punching operation, a down size file truncation, and an up size file truncation.

According to some embodiments of the present invention, the at least one file system operation may include at least one of: calculating a delta between at least two snapshots; replicating at least part of the files on the files system, carrying out a backup of at least part of the files on the file system.

Other embodiments of the present invention include a distributed shared file system (DSFS) implementing the aforementioned method and a computer readable medium configured to store instructions causing at least one processors to perform the aforementioned method.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a system in accordance with the prior art;

FIG. 2 is a block diagram an aspect of a system in accordance with the prior art;

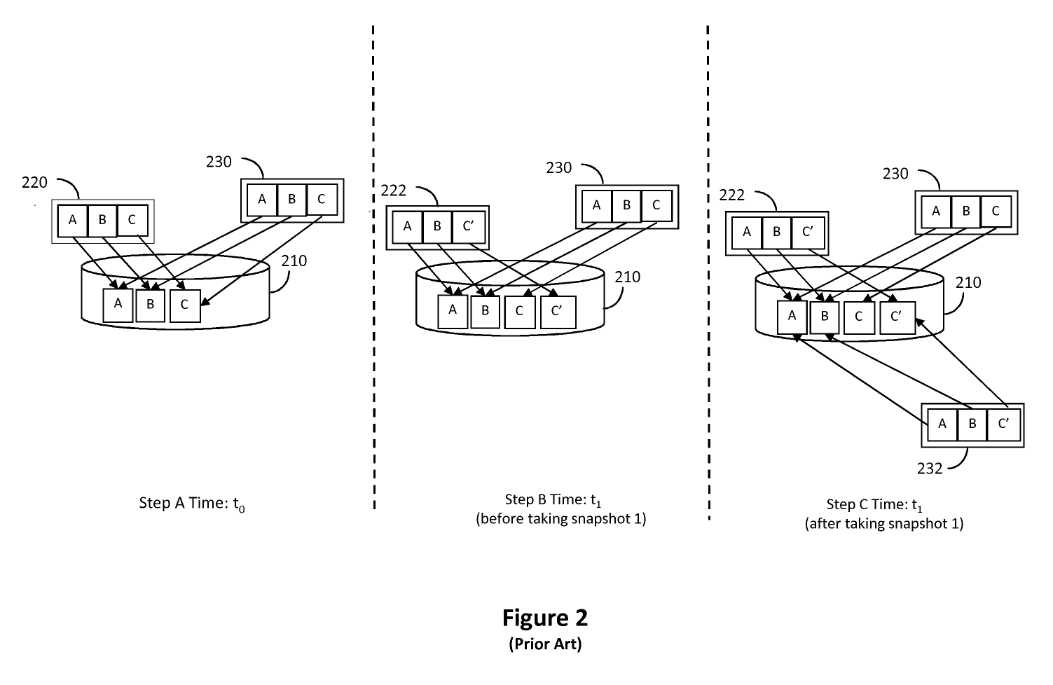

FIG. 3 is a block diagram an aspect of a system in accordance with embodiments of the present invention; and

FIG. 4 is a high level flowchart illustrating a non-limiting exemplary method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of present invention extends the “ownership” concept introduced in U.S. Pat. No. 7,913,046 which is incorporated herein by its entirety, beyond data extents to cover also unmapped extents (referred herein as “nulled extent”). When a snapshot is created, ownership information will also indicate the status of the nulled extents on top of the data extents. As with data ownership, the null ownership by a snapshot will significantly reduce the amount of work needed to be carried out when calculating deltas and any operation that requires carrying out delta operations (such as replication and backup). Specifically, the extra work occurring with shared nulls will be eliminated as will be explained in further details below.

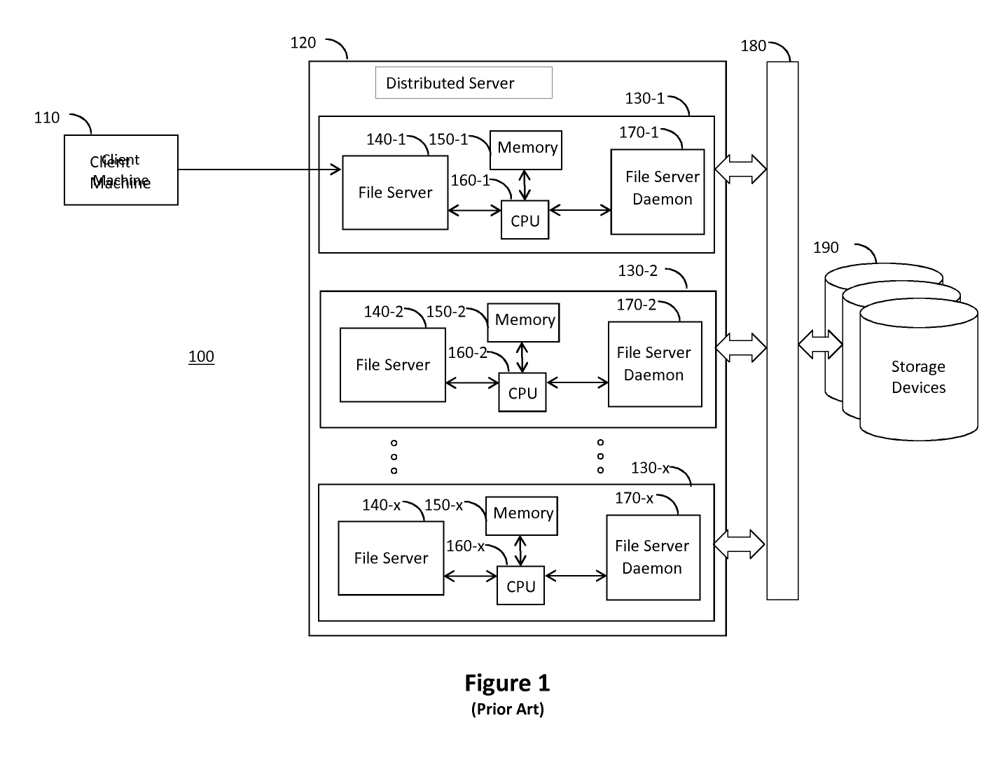

Embodiments of the present invention may be implemented over a distributed file system such as file system 120 of FIG. 1 which may include a plurality of nodes 130-1 to 130-x, each node comprising at least one processor 170-1 to 170-x; and a plurality of block storage devices 190 connected to the nodes over a file channel 180.

According to embodiments of the present invention at least one of processors 170-1 to 170-x is configured to: create, at a specified time period, a snapshot of a file system, wherein the file system includes at least one data extent and at least one unmapped extent, wherein the data extent and the at least one unmapped extent are indicated as owned by the snapshot; create, at a time period later than the specified time period, a subsequent snapshot of said file system, wherein the at least one unmapped extent is maintained from the specified time period; indicate the at least one unmapped extent maintained from the specified time period as an unmapped extent shared by the subsequent snapshot and owned by the snapshot; and apply at least one file system operation which requires calculating a delta between snapshots, wherein during the calculating of the delta, whenever an unmapped extent is indicted as a shared unmapped extent, a punching of a corresponding extent at the delta is eliminated.

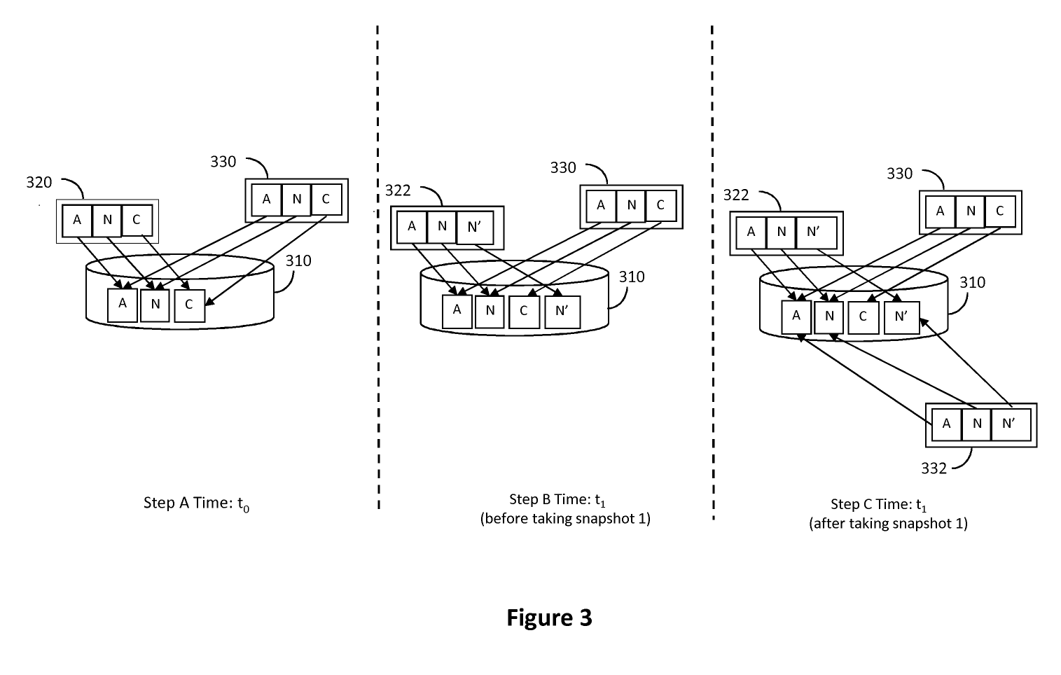

FIG. 3 is a block diagram illustrates in further details the aforementioned functionality of the system in accordance with embodiments of the present invention. Active file 320 in step A includes two data sections (A and C) and an unmapped null section (N). Snapshot S₀ 330 reflects this mapping so that A, C as well as Null N in file system 310 (which may be similar to file system 120 of FIG. 1) are owned by Snapshot S₀ 330.

In case that in timestamp t₁ active file 322 is punctured by a new null N′ will replace data extent C. When the next snapshot S₁ 332 is taken, the newly introduced null N′ is indicated as owned by snapshot S₁ 332 Thus, in accordance with embodiments of the present invention, after the snapshot at t₁ is taken, data extent A and unmapped extent N are shared by snapshot S₁332 and N′ is owned by snapshot S₁332.

In accordance with the prior art, whenever a file on a file systems needs to be replicated, three operations need to be carried out: in the first one, the data on the Mode (being the data structure used to represent a file system object) is being replicated. On the second step, a certain range with its data (logical range+data) is being replicated. On a third step a hole is punched inside the target side (whenever a nullified area was encountered) in a logical range

Advantageously over the prior art, when a delta needs to be calculated between Snapshot S₀ 330 and snapshot S₁ 332, shared null N is identified as such and need not be copied, transmitted, or handled. Specifically, all replication operations relating to shared extents, including null extents, are ignored (besides replicating the Mode data).

In other words, out of the aforementioned steps necessary for accomplishing a replication in a file system, steps two and step three need are only applied to owned extents in a specified logical range. The shared extents, of both data and null are ignored.

Since statistically, there may be numerous shared nulls between many snapshots taken in a file system, the indication of nulls as shared between several snapshots will significantly reduce the complexity of various files system operations such has replication and backup.

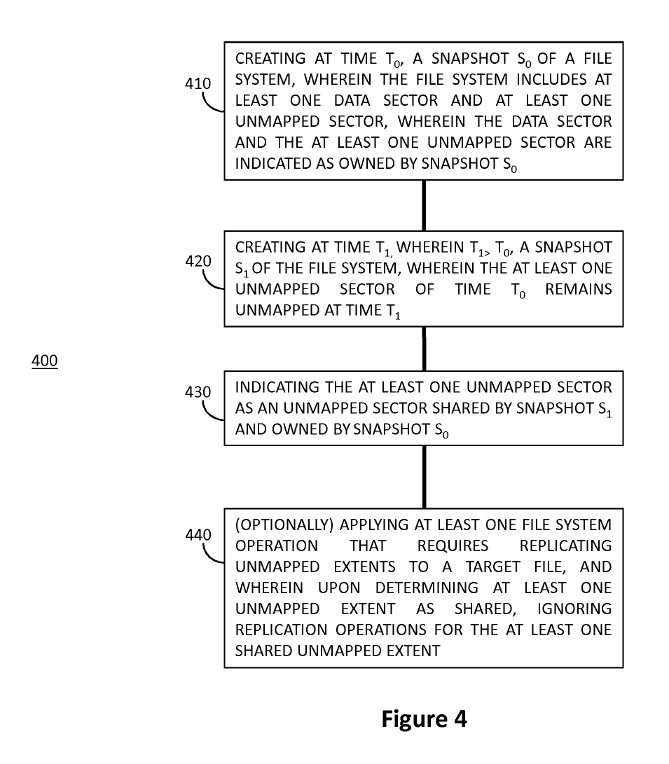

FIG. 4 is a high level flowchart illustrating a non-limiting exemplary method in accordance with embodiments of the present invention. Method 400 for efficient replication of files using shared null mappings when having trim operations on files may include the following steps: creating at time t₀, a snapshot S₀ of a file system, wherein said file system includes at least one data extent and at least one unmapped extent, wherein the data extent and the at least one unmapped extent are indicated as owned by snapshot S₀ 410; creating at time t₁, wherein t₁>t₀, a snapshot S₁ of said file system, wherein said at least one unmapped extent of time t₀ remains unmapped at time t₁ 420; indicating said at least one unmapped extent as an unmapped extent shared by snapshot S₁ and owned by snapshot S₀ 430; and optionally applying at least one file system operation that requires replicating unmapped extents to a target file, and wherein upon determining at least one unmapped extent as shared, ignoring replication operations for the at least one shared unmapped extent 440.

According to some embodiments of the present invention, the snapshot created at the specified time period may be a first snapshot ever created for the file system. The generation of the original snapshot will be a comprehensive one and will include all mapping to the data extents on the file system.

According to some embodiments of the present invention, the snapshot may include an entire memory mapping of the content of at least one active file onto corresponding blocks on the file system.

According to some embodiments of the present invention, the at least one unmapped extent (null) may include at least one of: an area that originally remained unmapped upon creation of a file; an area whose mapping was intentionally removed. Specifically, in a case that the mapping was intentionally removed, this may have been carried out by at least one of: a punching operations, a down file size truncation, and an up down file size truncation.

According to some embodiments of the present invention, at least one file system operation may include at least one of; a replication of at least part of the files on the files system, and a backup of at least part of the files on the file system.

According to some embodiments of the present invention, the method is implemented on a file system that is a distributed file system comprising a plurality of nodes, each of the nodes is associated with a plurality of specific files accessible via the file system.

It should be noted that methods according to embodiments of the present invention may be stored as instructions in a computer readable medium to cause processors, such as central processing units (CPU) 160-1 to 160-x, to perform the method. Additionally, the methods described in the present disclosure can be stored as instructions in a non-transitory computer readable medium, such as storage devices 190 which may include hard disk drives, solid state drives, flash memories, and the like. Additionally non-transitory computer readable medium can be memory units 150-1 to 150-x which reside on nodes 130-1 to 130-x of file system 120.

According to some embodiments of the present invention, the aforementioned non-transitory computer readable medium may include a set of instructions that when executed cause a processor to: create, at a specified time period, a snapshot of a file system, wherein the file system includes at least one data extent and at least one unmapped extent, wherein the data extent and the at least one unmapped extent are indicated as owned by the snapshot; create, at a time period later than the specified time period, a subsequent snapshot of said file system, wherein the at least one unmapped extent is maintained from the specified time period; indicate the at least one unmapped extent maintained from the specified time period as an unmapped extent shared by the subsequent snapshot and owned by the snapshot; and apply at least one file system operation which requires calculating a delta between snapshots, wherein during the calculating of the delta, whenever an unmapped extent is indicted as a shared unmapped extent, a punching of a corresponding extent at the delta is eliminated.

According to some embodiments of the present invention, in non-transitory computer readable medium, the snapshot created at the specified time period is a first snapshot created for the file system.

According to some embodiments of the present invention, in non-transitory computer readable medium, the snapshot may include an entire memory mapping of the content of at least one active file onto corresponding blocks on the file system.

According to some embodiments of the present invention, in non-transitory computer readable medium, the at least one unmapped extent comprises at least one of: an area that originally remained unmapped upon creation of a file; an area whose mapping was intentionally removed.

According to some embodiments of the present invention, in non-transitory computer readable medium, in a case the mapping was intentionally removed, it had been carried out by at least one of: a punching operations, a down file size truncation, and an up down file size truncation.

According to some embodiments of the present invention, in non-transitory computer readable medium, the at least one file system operation may include at least one of: a replication of at least part of the files on the files system, and a backup of at least part of the files on the file system.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
creating at time t₀, a snapshot S₀ of a file system, wherein said file system includes at least one data extent and at least one unmapped extent, wherein the data extent and the at least one unmapped extent are indicated as owned by snapshot S₀;
creating at time t₁, wherein t₁>t₀, a snapshot S₁ of said file system, wherein said at least one unmapped extent of time t₀ remains unmapped at time t₁; and
indicating said at least one unmapped extent as an unmapped extent shared by snapshot S₁ and owned by snapshot S₀.

2. The method according to claim 1, further comprising: applying at least one file system operation that requires replicating unmapped extents to a target file, and wherein upon determining at least one unmapped extent as shared, ignoring replication operations for the at least one shared unmapped extent.

3. The method according to claim 1, wherein the at least one unmapped extent comprises at least one of: an area that originally remained unmapped upon creation of a file; an area whose mapping was intentionally removed after creation of the file.

4. The method according to claim 3, wherein the mapping was intentionally removed from the file by at least one of: a punching operation, a down size file truncation, and an up size file truncation.

5. The method according to claim 2, wherein said at least one file system operation comprises at least one of: calculating a delta between at least two snapshots; replicating at least part of the files on the files system, carrying out a backup of at least part of the files on the file system.

6. The method according to claim 1, wherein said snapshot S₀ is a first snapshot created for the file system.

7. The method according to claim 1, wherein said snapshot comprises an entire memory mapping of a content of at least one active file onto corresponding blocks on said file system.

8. The method according to claim 1, wherein said file system is a distributed file system comprising a plurality of nodes.

9. A system comprising
a distributed file system comprising a plurality of nodes, each node comprising at least one processor; and
a plurality of block storage devices connected to the nodes over a network interface, wherein said at least one processor is configured to:
create at time t₀, a snapshot S₀ of a file system, wherein said file system includes at least one data extent and at least one unmapped extent, wherein the data extent and the at least one unmapped extent are indicated as owned by snapshot S₀;
create at time t₁, wherein t₁>t₀, a snapshot S₁ of said file system, wherein said at least one unmapped extent of time t₀ remains unmapped at time t₁; and
indicate said at least one unmapped extent as an unmapped extent shared by snapshot S₁ and owned by snapshot S₀.

10. The system according to claim 9, wherein said computer processor is further configured to apply at least one file system operation that requires replicating unmapped extents to a target file, and wherein upon determining at least one an unmapped extent as shared, ignoring replication operations for the at least one shared unmapped extent.

11. The system according to claim 9, wherein the at least one unmapped extent comprises at least one of: an area that originally remained unmapped upon creation of a file; an area whose mapping was intentionally removed after creation of the file.

12. The system according to claim 11, wherein the mapping was intentionally removed from the file by at least one of: a punching operation, a down size file truncation, and an up size file truncation.

13. The system according to claim 10, wherein said at least one file system operation comprises at least one of: calculating a delta between at least two snapshots; replicating at least part of the files on the files system, carrying out a backup of at least part of the files on the file system.

14. The system according to claim 9, wherein said snapshot S₀ is a first snapshot created for the file system.

15. The system according to claim 9, wherein said snapshot comprises an entire memory mapping of a content of at least one active file onto corresponding blocks on said file system.

16. The system according to claim 9, wherein said file system is a distributed file system comprising a plurality of nodes.

17. A non-transitory computer readable medium comprising a set of instructions that when executed cause a processor to:
create at time t₀, a snapshot S₀ of a file system, wherein said file system includes at least one extent and at least one unmapped extent, wherein the data extent and the at least one unmapped extent are indicated as owned by snapshot S₀;
create at time t₁, wherein t₁>t₀, a snapshot S₁ of said file system, wherein said at least one unmapped extent of time t₀ remains unmapped at time t₁; and
indicate said at least one unmapped extent as an unmapped extent shared by snapshot S₁ and owned by snapshot S₀.

18. The non-transitory computer readable medium according to claim 17, wherein said set of instructions, when executed further cause said processor to apply at least one file system operation that requires replicating unmapped extents to a target file, and wherein upon determining at least one an unmapped extent as shared, ignoring replication operations for the at least one shared unmapped extent.

19. The non-transitory computer readable medium according to claim 17, wherein the at least one unmapped extent comprises at least one of: an area that originally remained unmapped upon creation of a file; an area whose mapping was intentionally removed after creation of the file.

20. The non-transitory computer readable medium according to claim 17, wherein said at least one file system operation comprises at least one of: calculating a delta between at least two snapshots; replicating at least part of the files on the files system, carrying out a backup of at least part of the files on the file system.
